(19) United States
(12) Patent Application Publication
(10) Pub. No.: US 2026/0369905 A1
(43) Pub. Date: Nov. 19, 2026

(54) CONDUCTOR TERMINAL

(71) Applicant: WAGO Verwaltungsgesellschaft mbH, Minden (DE)

(72) Inventors: Sergej ISAAK, Stedesdorf (DE); Michael MEYER, Wiedensahl (DE)

(73) Assignee: WAGO Verwaltungsgesellschaft mbH, Minden (DE)

(21) Appl. No.: 19/676,525

(22) Filed: May 13, 2026

(30) Foreign Application Priority Data
May 14, 2025 (DE) 20 2025 102 653.8

(51) Int. Cl. H01R 9/24

(52) U.S. Cl. CPC H01R 9/2416

(57) ABSTRACT

A conductor terminal with an insulating material housing, a busbar, and a clamping spring. The clamping spring has a contact leg and a clamping leg that together with the busbar forms a clamping point for an electrical conductor through a conductor insertion channel into a conductor-receiving space of the conductor terminal. The clamping leg can be moved between an open position and a closed position. The conductor terminal has a retaining contour for holding the clamping leg in the open position and a release mechanism, which can be actuated by the inserted electrical conductor, for releasing and automatically moving the clamping leg into the closed position. The conductor terminal has a pivotable actuating lever with an operating section, which can be pivoted in an actuation direction from a ready position into an actuating position, for moving the clamping leg from the closed position into the open position.

This nonprovisional application claims priority under 35 U.S.C. § 119(a) to German Patent Application No. 20 2025 102 653.8, which was filed in Germany on May. 14, 2025, and which is herein incorporated by reference.

### BACKGROUND OF THE INVENTION

### FIELD OF THE INVENTION

The invention relates to a conductor terminal with an insulating material housing, a busbar, and a clamping spring, wherein the clamping spring has a contact leg and a clamping leg, wherein the clamping leg together with the busbar forms a clamping point for an electrical conductor which can be inserted, in a conductor insertion direction, through a conductor insertion channel into a conductor-rreceiving space of the conductor terminal, wherein the clamping leg can be moved between an open position and a closed position for opening and closing the clamping point, wherein the conductor terminal has a retaining contour for holding the clamping leg in the open position and a release mechanism, which can be actuated by the inserted electrical conductor, for releasing and automatically moving the clamping leg into the closed position, and wherein the conductor terminal has a pivotable actuating lever with an operating section, which can be pivoted in an actuation direction from a ready position into an actuating position, for moving the clamping leg from the closed position into the open position.

### DESCRIPTION OF THE BACKGROUND ART

Conductor terminals are known in practice. These are conductor terminals with automatic connection of the electrical conductor to be connected when it is inserted into the conductor terminal. For this purpose, the conductor terminal is designed to temporarily hold the clamping leg of the clamping spring in the open position. By inserting the electrical conductor into the conductor terminal, the clamping leg held in the open position can be automatically released and cause the electrical conductor to be clamped in the closed position. A simple and convenient connection of an electrical conductor using the conductor terminal is made possible hereby. The clamping leg can be moved to the open position by actuating the operating lever, for example, to prepare an intended conductor connection or to be able to release and remove a clamped conductor.

With regard to such conductor terminals, it is desirable to further improve user comfort for a user of the conductor terminal. This can be achieved in particular by easier handling of the actuating lever, but also, for example, by improved conductor guidance when inserting the electrical conductor, and by a reliably effective automatic connection mechanism while at the same time preventing premature triggering of the clamping leg release. A compact design of the conductor terminal can be maintained despite the increased user convenience due to the clever design coordination of the actuating mechanism, the conductor guide, and the automatic connection mechanism.

### SUMMARY OF THE INVENTION

It is therefore an object of the present invention to create an improved conductor terminal.

It is proposed, in an example, that the actuation direction of the operating section is opposite to the conductor insertion direction of the electrical conductor. This enables easier and intuitive operation of the operating lever for a user who can exert a tensile force on the operating section to pivot it while it is facing a conductor insertion opening of the conductor terminal. In other words, the actuating lever operating section gripped by the operator is moved with a pivoting movement from an insulating material housing side, facing away from the conductor insertion opening, into the actuating position in the direction of the housing side with the conductor insertion opening. It was recognized that not only the actuating force to be applied, but also the actuation direction can have an influence on the comfortable handling of a conductor terminal, especially in the case of manual actuation. In addition, with an actuating lever designed in this way, an actuating mechanism for moving the clamping leg into the open position can be realized which combines a compact design with a favorable force ratio, so that the clamping leg can be reliably moved even with a low actuating force.

The insulating material housing of the conductor terminal, the material housing which is made of a plastic material, for example, accommodates the busbar and the clamping spring of the conductor terminal and protects them from environmental influences and contact. The insulating material housing can have a conductor insertion channel.

The conductor insertion channel can form an insertion channel, for example, at least partially cylindrical or funnel-shaped and leading to the clamping point of the conductor terminal with a conductor insertion opening, into which an end section of an electrical conductor can be inserted into the insulating material housing in the conductor insertion direction and removed from the insulating material housing in the direction opposite to the conductor insertion direction.

The insulating material housing can be formed of multiple parts with a base housing and a cover part which closes the base housing. The cover part can be a side cover, for example, which forms a side wall on a conductor terminal side opposite the conductor insertion opening. Such a side cover can face a release section of the release mechanism of the conductor terminal. The cover part can also be formed as the upper part of the conductor terminal and, at least partially, form an upper conductor terminal side which extends transversely to the side wall and on which the actuating lever is arranged. In particular, the actuating lever and a contact insert with the busbar, the clamping spring, and optionally a functional element, described below, can be pre-assembled on such an upper part in order to bring these components together with the base housing in a simple manner and to facilitate assembly.

The electrical conductor which can be inserted into the conductor terminal can be, in particular, a flexible conductor which is inserted into the conductor terminal with a stripped end first.

The busbar can be a largely rigid electrical conductor and have, for example, a strip‑shaped connecting bar with a clamping surface against which the electrical conductor can be clamped in the connected state by means of the spring force of the clamping spring. The clamping surface can be formed by a predominantly flat clamping surface or a contact projection. The contact projection can be connected to a conductor‑receiving corrugation introduced into the plane of the busbar or formed by the conductor‑receiving corrugation.

The clamping spring of the conductor terminal can be an elastically resilient, predominantly flat component. The clamping spring can, for example, be a bent sheet metal part made from a spring plate. The clamping spring has a contact leg for supporting the clamping spring on an adjacent structure, for example, on the busbar, on the insulating material housing, and/or on a functional element of the conductor terminal, described below, and a clamping leg for clamping the conductor to the busbar. The contact leg and the clamping leg can be connected to one another by a spring bow. The clamping leg can form a clamping point with the busbar for clamping the electrical conductor to the busbar, for example, by clamping the conductor to the busbar by a clamping edge at a free end of the clamping leg or by a clamping edge, released from the clamping leg, by means of the spring force of the clamping spring, so that a reliable electrical contact can be established. The clamping leg can be moved between an open position and a closed position for opening and closing the clamping point. In the open position of the clamping leg, the clamping edge is spaced apart from the busbar and any inserted electrical conductor, so that the clamping point is released and the conductor can be inserted into the conductor terminal and positioned in the area of the clamping point or removed from it. In the closed position of the clamping leg, the clamping edge is moved towards the busbar and the inserted electrical conductor and exerts a contact pressure on the electrical conductor in the direction of the busbar, so that electrical contact is made between the conductor and the busbar. When moving to the open position, the clamping leg can be moved towards the contact leg in particular.

The conductor terminal can have a retaining contour for holding the clamping leg in the open position and a release mechanism, which can be actuated by the inserted electrical conductor, for releasing and automatically moving the clamping leg into the closed position.

The retaining contour and the release mechanism can, for example, be formed by a retaining and release structure on the clamping spring, on the busbar, and/or on the insulating material housing. In particular, the retaining contour and the release mechanism can be formed on a separate functional element, as described in more detail hereinafter.

The clamping leg can be pretensioned in the direction of the contact leg by the spring force of the clamping spring in the open position. In the open position, the clamping leg can be supported by or latched to the retaining contour. Optionally, a dedicated counter‑contour for interaction with the retaining contour, for example, a retaining projection, can be formed on the clamping leg. If the release mechanism is actuated, this can cause a relative movement between the clamping leg and the retaining contour, which leads to the release of the support or latching of the clamping leg on the retaining contour, whereby, as a result of spring force, the clamping leg is returned to its closed position.

The retaining contour can be moved between a retaining position for holding the clamping leg and a release position for releasing the clamping leg.

The conductor terminal can have a pivotable actuating lever with an operating section that can be pivoted in an actuation direction from a ready position into an actuating position for moving the clamping leg from the closed position into the open position. A conveniently operated actuating element with an efficient leverage effect can be provided with a pivotable actuating lever. A pivotable actuating lever can be an actuating element with a predominantly rotational actuating path. The actuating lever can have an actuating section for mechanically contacting an actuating surface of the clamping leg.

The clamping leg can have a dedicated actuating contour, for example, a laterally projecting actuating tab on which the actuating surface is formed.

In the ready position of the operating section, the actuating section of the actuating lever can be spaced apart from the actuating surface of the clamping leg or can make mechanical contact with it without exerting a force. When the operating section is pivoted from the ready position to the actuating position, the actuating force is transmitted via the actuating section to the actuating surface of the clamping leg, and the leg is moved to the open position thereby. In the ready position, the operating section, which is configured in particular for manual gripping, may rest against the insulating material housing or, compared to the actuating position, positioned closer to a surface of the insulating material housing.

In the actuating position, the operating section can be pivoted relative to the insulating material housing and enclose a defined position angle with the surface of the insulating material housing.

The operating section can have a cover with a continuous surface, resulting in improved clearance and creepage distances of the conductor terminal in the ready position.

It is provided that the actuation direction of the operating section can be opposite to the conductor insertion direction of the electrical conductor. For this reason, particularly with regard to a predominantly linear insertion movement of the conductor and a predominantly rotational pivoting movement of the operating section, no precise reversal of the respective spatial axis is required, but rather a rough direction of displacement of the conductor and the operating section relative to the insulating material housing.

For example, the operating section can be configured to perform a pivoting movement along an arc section between the ready position and the actuating position, wherein a tangential auxiliary spatial direction at the arc section at the point of the actuating position can be directed opposite to the conductor insertion direction, in particular with disregard for any angular deviations of up to 20° between the auxiliary spatial direction and the conductor insertion direction. Stated simply, one conductor end of the inserted conductor can be moved away from a user of the conductor terminal facing the conductor insertion opening in the conductor insertion direction and the operating section can be moved towards the user in the actuation direction. In other words, the actuating lever operating section, which can be gripped by the operator, can be moved from an insulating material housing side facing away from the conductor insertion opening into the actuating position with a pivoting movement in the direction of the housing side with the conductor insertion opening.

The conductor terminal can be made multipole, therefore, designed for multiple connection with multiple clamping points for electrical conductors, points which are arranged next to one another in a common insulating material housing. For such a multiple connection, a continuous common busbar as well as separate actuating levers, clamping springs, and/or functional elements for the respective connection points can be arranged in the conductor terminal.

The actuating lever can be pivoted about an axis of rotation that runs offset from the conductor insertion channel and the conductor-receiving space. As a result, a compact and stable actuating mechanism with a favorable force ratio can be achieved. The axis of rotation can therefore run outside a conductor area of the conductor terminal. The axis of rotation can, for example, extend between the conductor insertion channel or the conductor-receiving space and a contact leg of the clamping spring at right angles to the conductor insertion direction. The axis of rotation can run closer to a top side accommodating the operating section than to an opposite underside of the insulating material housing.

The actuating lever can be mounted on the busbar and/or on the insulating material housing. This enables stable mounting of the operating lever with a compact design of the conductor terminal. The actuating lever can have a bearing contour that is designed to support and slide on a counter-bearing contour of the busbar and/or the insulating material housing. The actuating lever can, for example, have a bearing disk with an arcuate contour, at least partially, which can roll on a counter-bearing of the busbar and/or the insulating material housing. In particular, a stable bearing to improve the user experience when operating the operating lever can be achieved with a large bearing disk, whose surface can cover, for example, more than 60% or more than 70% of the entire side surface of the operating lever. A large bearing disk can also be used to form a guiding surface with few interfering edges for an inserted electrical conductor, so that secure conductor insertion along the bearing disk is made possible with a low risk of levering off or splaying.

The actuating lever can be configured to perform an idle stroke at a pivoting angle of the operating section of at least 15° between the ready position and an operating position. This can make it easier to operate the actuating lever, because an initial application of force can be converted into an acceleration of the actuating lever, which can reduce the force exerted for a subsequent working stroke from the working position to the actuating position. The intended pivoting angle for the idle stroke can, in particular, be at least 20° or at least 25°. For implementation, for example, a defined free space can be provided, in the ready position of the operating section, between the actuating section of the actuating lever and the actuating surface of the clamping leg.

The operating section can be pivoted through a pivoting angle of at least 60° between the ready position and the actuating position. A favorable force transmission to the clamping leg can occur as a result and the operating section can be pivoted into a stable angular position relative to the insulating material housing. In addition, such large pivoting angles can improve the user experience in order to convey a secure moving of the clamping leg into the open position. The pivoting angle between the ready position and the actuated position can be at least 65° or at least 70° in particular. The example described can be combined in particular with the example described above, according to which the actuating lever is configured to perform an idle stroke at a pivoting angle of the operating section of at least 15° between the ready position and an operating position. If part of the intended pivoting angle between the ready position and the actuating position is already used for an idle stroke, a compact actuating mechanism can be combined with a favorable angular position in the actuating position.

The actuating lever can have a U-shape with bearing legs that run parallel to one another and are connected to one another by a crossbar, wherein an actuating wing is located between the bearing legs for mechanical contacting of the clamping leg. This provides a compact and yet stable operating lever with a symmetrical bearing, which contributes to comfortable operation of the operating lever. The operating section of the actuating lever can be at least partially formed by the crossbar.

The bearing legs can each have a bearing disk that merges into a side section of the operating section of the actuating lever, wherein the side sections of the operating section are connected to one another via the crossbar. The crossbar can form an operating edge that can be gripped by a user of the conductor terminal and can be used to apply force to the actuating lever. A cover can be arranged between the side sections, starting from the operating edge and extending parallel to the top side of the insulating material housing in the ready position of the operating section and contributing to an improvement in the clearance and creepage distances. The actuating wing can extend substantially parallel to the bearing legs and can be anchored to one of the bearing legs.

The actuating wing can be spaced from the bearing leg by a slot. Optionally, a housing wall of the insulating material housing can enter the slot and support a pivoting movement of the actuating lever by means of the guiding.

In particular, the actuating lever can have two actuating wings, which in each case project from a bearing leg and extend parallel to one another between the bearing legs in order to enable a symmetrical force transmission into the clamping leg.

An actuating section can be formed on the actuating wing. The actuating section can, for example, be formed by an actuating contour on an outer edge of the actuating wing, which enables force to be transmitted from the actuating lever to the actuating surface of the clamping leg. The actuating lever can have an axially symmetrical design with respect to an axis of symmetry running centrally between the bearing legs.

An actuating surface of the clamping leg can be formed in an end section of the clamping leg. As a result, a force can be introduced into the clamping leg by the actuating section of the actuating lever near to a free end of the clamping leg, whereby a favorable leverage ratio with a pronounced lever arm along the clamping leg can be achieved, so that the clamping leg can be moved into the open position with little actuating force. Starting from an end edge of the clamping leg, for example, the end section of the clamping leg can have a length that corresponds to a maximum of 10% of a total length of the clamping leg between the end edge and a peak of a spring bow connecting the contact leg to the clamping leg.

Alternatively, an actuating surface of the clamping leg can be formed in a central section of the clamping leg. As a result, the clamping leg can be moved into the open position with a shorter actuation path compared to the previously described example. The central section can connect to the end section and end, for example, at a transition of the clamping leg into the spring bow. The clamping leg can have a bend in the middle section where the actuating surface of the clamping leg is formed.

A housing wall of the insulating material housing can be arranged at least partially between the actuating lever and the conductor-receiving space and/or the conductor insertion channel. As a result, there is an improved spatial separation of the actuating area and the conductor area, which can make it easier to insert the electrical conductor, for example. In particular, the housing wall can form a predominantly flat guiding surface, therefore, be substantially free of interfering edges on which the conductor can lever off or get caught. The user experience when operating the conductor terminal can be increased by such an improved conductor guidance.

In particular, the housing wall can run between a bearing section of the actuating lever, for example, a bearing disk, and the clamping leg. In particular, the housing wall can run between the actuating section and, for example, a strip-shaped base body of the clamping leg, wherein, as explained below, an actuating surface of the clamping leg can be guided around the housing wall and can be contacted there by the actuating section. To implement the example, for example, an actuating wing of a U-shaped actuating lever can be made very narrow and/or arranged very close to the bearing leg, thus creating an installation space available for the housing wall. For example, the actuating wing can have a width between the bearing legs that corresponds to a maximum of 100% or a maximum of 80% of the width of the bearing legs. For example, the actuating wing can have a maximum distance to an adjacent bearing leg that corresponds to a maximum of 100% or a maximum of 80% of a width of the bearing leg.

By suitably designing the actuating lever so that a housing wall for improved conductor guidance can be implemented between the actuating lever and the conductor area, it becomes clear how the various functional areas of the conductor terminal can be coordinated for improved user comfort.

An actuating surface of the clamping leg can be formed on a laterally projecting actuating tab of the clamping leg, wherein the actuating tab is spaced from the clamping leg by a gap and wherein the housing wall enters the gap. A spatial separation of the actuating area and the conductor area is made possible hereby, which reduces possible interfering edges and improves conductor guidance in the conductor terminal. The actuating tab can project laterally from the base body of the clamping leg via a connecting web and can be guided around the housing wall.

The conductor terminal can have a functional element on which a retaining section with the retaining contour for holding the clamping leg in the open position and a release section which can be mechanically contacted by the inserted conductor for releasing the clamping leg are formed. In particular, the functional element can be a separate component of the conductor terminal in addition to the busbar, the clamping spring, and the insulating material housing. By means of a separate functional element, a specifically optimizable retaining contour and a design of the functional element tailored to the desired release mechanism are made possible, for example, with regard to the mobility, stability, and positioning of the retaining contour and the release section relative to the other components of the conductor terminal. In principle, however, it is also conceivable, for example, to form the retaining contour and the release section integrally with the clamping spring on an extension of the contact leg.

The retaining contour can, for example, be designed as a latching contour on which the clamping leg can be latched form-fittingly and/or force-fittingly. The release section can be embodied as a so-called release pedal, which is displaced by the conductor striking it and leads to a displacement or to an elastic deformation of the retaining section connected to the release section, whereby a temporary fixation of the clamping leg on the retaining contour can be removed.

The functional element can form a U-shape when viewed from the side, wherein the release section and the retaining section form the U-legs and these are connected to one another by a connecting section forming the U-base. A support tab for supporting the retaining section on the insulating material housing and/or a support contour for supporting the retaining section on a support frame of the busbar, described below, can be formed on the retaining section.

The functional element can have a pass-through opening for guiding the electrical conductor to the release section. This promotes a compact design of the conductor terminal. In particular, the pass-through opening can be arranged in the retaining section of the functional element. The retaining section can form a frame-like structure that defines the pass-through opening. In the open position, the clamping leg can optionally enter at least partially into the pass-through opening and be supported on the frame-shaped structure of the retaining section. The retaining contour can be, for example, a retaining contour projecting laterally from the retaining section into the pass-through opening.

The retaining contour can be formed as a latching projection projecting into the pass‑through opening. This enables a secure and space-efficient fixing of a clamping leg in the open position, which at least partially enters the pass-through opening. The latching projection can, for example, protrude from a frame-like structure of the retaining section, the structure delimiting the pass-through opening, into the pass-through opening. In particular, there may be two latching projections arranged on opposite sides of the pass‑through opening and projecting towards one another. A guide ramp can adjoin the latching projection in the direction of the clamping leg in the closed position, making it easier to center and guide the clamping leg into the open position and ensuring secure locking.

The retaining section and the release section can be connected to one another by two webs spaced apart from one another by a free space. As a result, even a slight displacement of the release section can be transferred to the retaining section and converted into a deflection or deformation of the retaining section, so that, for example, even conductors with small cross sections can reliably actuate the release section. In addition, the web connection enables a material-saving example of the functional element.

For example, the functional element can be made from a sheet metal part and the webs can be cut out of the sheet metal part. In particular, the webs can merge into a frame‑shaped retaining section that delimits the aforementioned pass-through opening. In particular, a deflection or elastic deformation of the retaining section can be caused by a tensile and/or bending load on the webs and on the retaining section without having to displace the entire functional element. The retaining contour can thus be pulled out of a latching engagement with the clamping leg in particular.

The webs can form a previously described connecting section of a U-shaped functional element and thereby form the U-base. The webs can be bent away from the retaining section, for example, at right angles. The free space and the pass-through opening can form a continuous pass-through opening of the functional element.

A housing section of the insulating material housing can enter into the free space between the webs and form a conductor-guiding surface for the inserted electrical conductor. As a result, a targeted guiding of the conductor to the release section can be made possible, wherein contact of the inserted conductor with the webs is avoided by the housing section, and thereby a levering off or catching of the conductor or premature triggering of the release mechanism can be avoided. The housing section also gives the functional element additional stability without impairing an easy movability of the release and retaining section. The housing section can, for example, be formed on a cover part of a multipart insulating material housing, for example, on a side cover or an upper part of the insulating material housing.

The functional element can be suspended from the contact leg of the clamping spring. This creates a self-supporting arrangement, so that a force-absorbing connection to other components of the conductor terminal can be avoided. For example, in the retaining section of the functional element, a cutout can be formed, which can be penetrated by a curved material tongue at the free end of the contact leg.

The functional element can have a lower material thickness than the clamping spring. For example, the functional element and the clamping spring can each be made from sheet metal parts, wherein the sheet metal part of the functional element is made thinner than the sheet metal part of the clamping spring. This provides a retaining section that can be easily deflected by displacing the release section or elastically deformed, so that, for example, conductors with small cross sections can also reliably actuate the release section, and at the same time a material-saving design of the functional element is enabled. In particular, the functional element can be optimized in terms of material technology with regard to its retaining and releasing function. When mounting the functional element, it can be arranged with a predefined preload in the conductor terminal in order to better absorb the active spring forces of the clamping spring.

The busbar can have a support frame and/or the functional element can have a support contour for supporting the functional element on the busbar. A stable hold of the functional element in the conductor terminal can be supported in this way. The support frame can, for example, be bent from a strip-shaped connecting bar of the busbar. The support frame can have a through opening, which corresponds to the pass-through opening of the retaining section and through which the clamping leg, the contact leg, and the electrical conductor can pass. The support frame can be designed to rest flat against the support contour of the functional element, at least partially. The support contour and the support frame can have a coordinated inner and/or outer contour, at least partially. The support contour can, for example, have two support struts running parallel to one another and are connected to one another by a crossbar. The support contour can frame the retaining section with the retaining contour in an arc, for example. The retaining section and the support contour can be formed in one piece with the functional element. The retaining section can be cut out of the support contour. The side bars of the retaining section can be compressed at the support contour above a root region of the retaining section, so that the side bars can move independently of the support contour.

The functional element can have a bearing bar for bearing against an underside of the busbar, the side facing away from a clamping surface or a clamping projection of the busbar. A stable hold of the functional element in the conductor terminal can be supported in this way. The bearing bar can be connected in a force-fitting manner to the busbar. Put simply, the bearing bar can be clamped under the busbar. The bearing bar can be configured to rest against the underside of a strip-shaped connecting bar of the busbar. A clamping tab can protrude from the bearing bar. A latching tab of the busbar, in particular a latching tab projecting from the connecting bar of the busbar, can be snap‑received between the clamping tab and a counter-contour, for example, the aforementioned support tab of the retaining section. As a result, the bearing bar can be supported securely against the underside of the busbar and an interengagement of the functional element with the busbar can be achieved.

The retaining section can have a abutment tab for contacting the clamping leg held in the open position. In particular, a clamping edge of the clamping leg can be supported on the abutment tab. This ensures a defined overlap of the retaining contours that is independent of manufacturing and assembly tolerances relative to a clamping edge of the clamping leg, so that defined, uniform release forces can always be ensured. The abutment tab can connect two parallel side webs of the retaining section to one another and extend predominantly transverse to the side webs for this purpose. The abutment tab can be bent or angled away from the retaining section, in particular from the side webs of the retaining section. The abutment tab can form a stop for the clamping leg, which is moved into the open position by the actuating lever. In addition, the aforementioned material tongue of the contact leg can be supported on the abutment tab on a side of the abutment tab facing away from the clamping leg.

With the conductor terminal described in accordance with the proposed features, partly in conjunction with the examples explained, a conductor terminal with a tool-free conductor connection is provided, which, due to an actuation direction opposite to the conductor insertion direction and due to favorable lever ratios, can be easily operated with low actuation forces and can be formed in a compact manner. The clamping spring of the conductor terminal can be designed with a simple spring geometry, so that bulk material suitability and tempering process suitability as well as favorable spring properties can be maintained. By selecting different materials for the clamping spring and the functional element, these can be designed individually with regard to their respective functions. The conductor terminal can be manufactured and assembled securely and easily due to the geometrically simply held components of the conductor terminal. The conductor terminal described is associated with a high user convenience due to an improved actuation mechanism and, optionally, an improved conductor guiding and a reliably effective release mechanism for the automatic conductor connection.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a conductor terminal according to an example with an open clamping point in a sectional side view;

FIG. 2 shows the conductor terminal according to the example with an inserted conductor and closed clamping point in a sectional side view;

FIG. 3 shows the conductor terminal according to the example with an actuating lever, moved into an actuating position, in a sectional side view;

FIG. 4 shows an assembly of the conductor terminal according to the example in a perspective view;

FIG. 5 shows a busbar of the conductor terminal according to the example in a perspective view;

FIG. 6 shows a functional element of the conductor terminal according to the example in a perspective view;

FIG. 7 shows an actuating lever of the conductor terminal according to the example in a perspective view;

FIG. 8 shows a clamping spring of the conductor terminal according to the example in a perspective view;

FIG. 9 shows a conductor terminal according to a second example with an open clamping point in a sectional side view;

FIG. 10 shows the conductor terminal according to the second example with an inserted conductor and closed clamping point in a sectional side view;

FIG. 11 shows the conductor terminal according to the second example with an actuating lever, moved into an actuating position, in a sectional side view;

FIG. 12 shows an assembly of the conductor terminal according to the second example in a perspective view;

FIG. 13 shows a busbar of the conductor terminal according to the second example in a perspective view;

FIG. 14 shows a functional element of the conductor terminal according to the second example in a perspective view;

FIG. 15 shows an actuating lever of the conductor terminal according to the second example in a perspective view;

FIG. 16 shows the busbar, the clamping spring, and the actuating lever of the conductor terminal according to the second example in a sectional side view;

FIG. 17 shows a conductor terminal according to a third example with a closed clamping point in a sectioned perspective view;

FIG. 18 shows the conductor terminal according to the third example with an open clamping point in a sectional perspective view.

### DETAILED DESCRIPTION

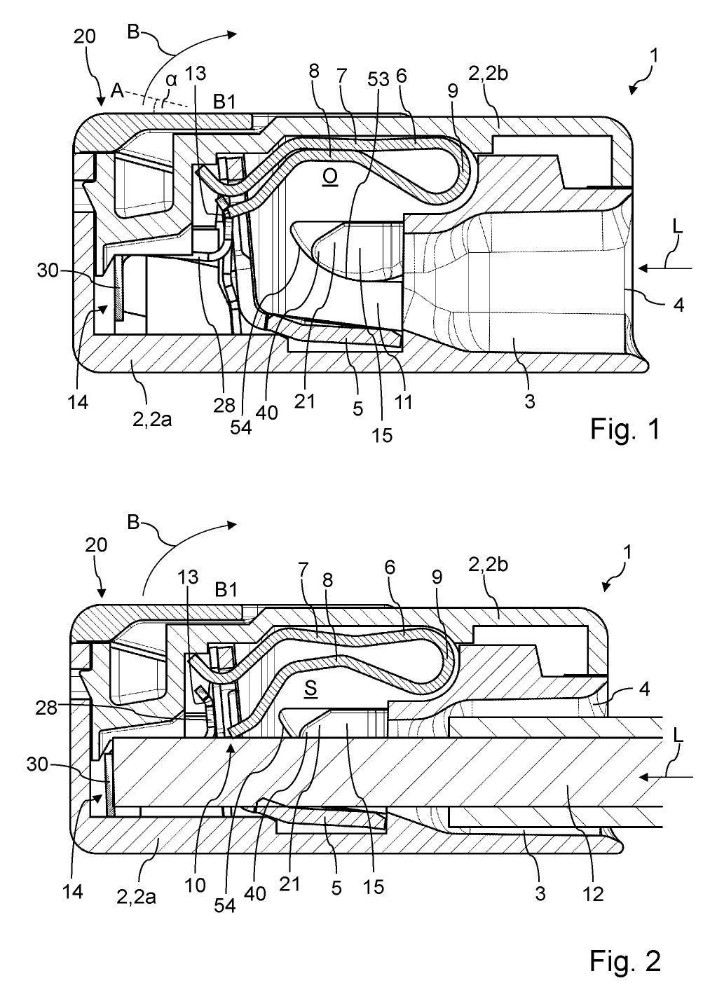

FIGS. 1-8 show a conductor terminal 1 and selected assemblies and components of conductor terminal 1 according to a first example. Conductor terminal 1 is configured for automatic connection of an electrical conductor 12, shown in FIG. 2, when it is inserted into conductor terminal 1. FIGS. 1-3 illustrate different states of conductor terminal 1. As shown in FIGS. 4-8, conductor terminal 1 is made multipole and, according to the example shown, enables connection of up to three electrical conductors 12 next to one another at conductor terminal 1. For the sake of simplicity, conductor terminal 1 is only described below with regard to one of the connections. The additional connections can be designed analogously in terms of their structure and function.

As can be gathered from FIGS. 1-3, conductor terminal 1 has an insulating material housing 2 for the protected accommodation of the electrically conductive components of conductor terminal 1. Insulating material housing 2 has for each connection a conductor insertion channel 3 with a conductor insertion opening 4, into which an electrical conductor 12 can be inserted into insulating material housing 2 in a conductor insertion direction L and removed from it in the opposite direction to conductor insertion direction L. It can be seen in FIGS. 1-3 that insulating material housing 2 is formed of multiple parts and formed of a base housing 2a and a cover part 2b made as an upper part.

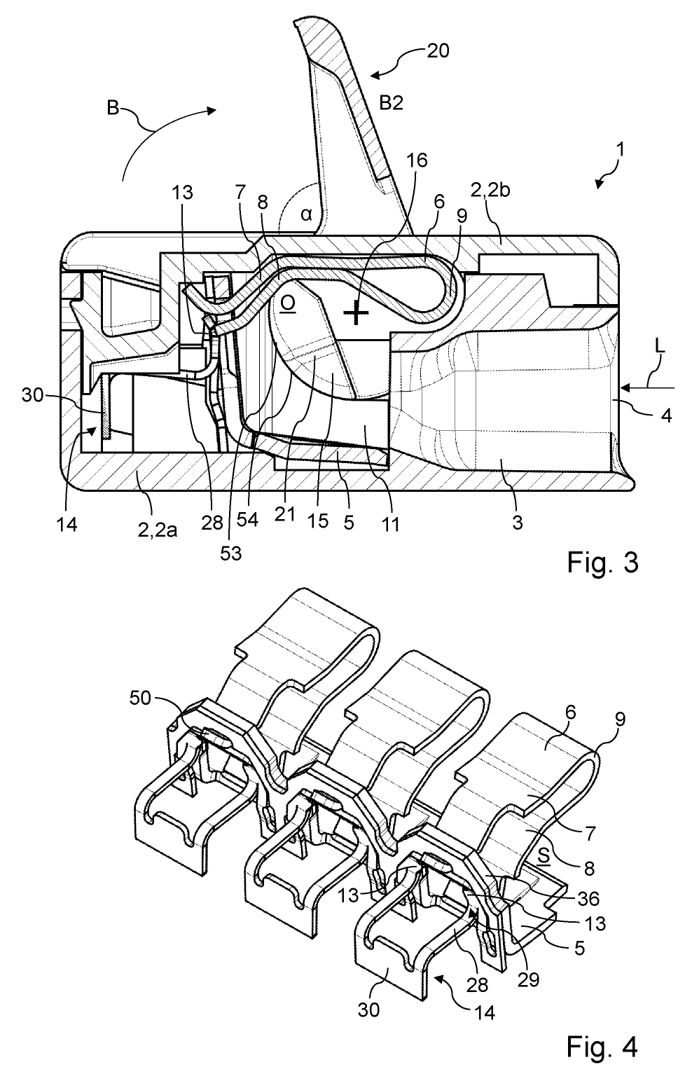

Conductor terminal 1 has one clamping spring 6 per connection. Conductor terminal 1 also has a busbar 5 to which electrical conductor 12 can be clamped by means of the spring force of clamping spring 6. Clamping spring 6 has a contact leg 7 for support on busbar 5 and a functional element 28, described below, and a clamping leg 8 for clamping electrical conductor 12. Contact leg 7 and clamping leg 8 are connected to one another by a spring bow 9. Together with busbar 5, clamping leg 8 forms a clamping point 10, shown in FIG. 2, for an electrical conductor 12 that can be inserted in conductor insertion direction L through a conductor insertion channel 3 into a conductor-receiving space 11 of conductor terminal 1. Clamping leg 8 can be moved between an open position O, shown in FIGS. 1 and 3, and a closed position S shown in FIG. 2. In the open position O, a clamping edge 43 of clamping leg 8, shown in FIG. 8, is spaced from busbar 5 and electrical conductor 12. In the closed position S, clamping edge 43 is in contact with electrical conductor 12 or, in the absence of an inserted conductor 12, with busbar 5. Conductor terminal 1 has a retaining contour 13 for holding clamping leg 8 in the open position O and a release mechanism 14 that can be actuated by inserted conductor 12, shown in FIG. 2, to release and automatically move clamping leg 8 to closed position S. By actuating release mechanism 14, clamping leg 8 can be released from engagement with retaining contour 13 and, due to the spring force, automatically moved into its closed position S.

As can be gathered further from FIGS. 1-3, conductor terminal 1 has a pivotable actuating lever 15 with an operating section 20 and an actuating section 40. Operating section 20 can be pivoted in an actuation direction B from a ready position B1, shown in FIGS. 1 and 2, to an actuating position B2, shown in FIG. 3, in order to move clamping leg 8 from the closed position S to the open position O. As indicated by the arrow representations in FIGS. 1-3, the actuation direction B of operating section 20 is opposite to the conductor insertion direction L of electrical conductor 12, with which an easier manual actuation of actuating lever 15 is associated and a compact actuating mechanism with low actuating forces can be realized.

FIG. 3 further illustrates that actuating lever 15 is pivotable about an axis of rotation 16 which runs offset from conductor insertion channel 3 and conductor-receiving space 11, thus providing a compact and stable actuating mechanism. As can be seen in FIG. 3, the axis of rotation 16 runs between conductor-receiving space 11 and contact leg 7 of clamping spring 6 and is arranged closer to an upper side of conductor terminal 1 that receives operating section 20 than to an opposite underside. Actuating lever 15 is mounted on insulating material housing 2.

It can also be seen in FIGS. 1-3 that actuating lever 15 has a bearing disk 18. This is mounted with an arcuate bearing contour 53, here with a partially circular outer surface, on a correspondingly partially circular, arcuate counter-bearing contour 54 of insulating material housing 2, here cover part 2b, and can be guided along counter-bearing contour 54 during a pivoting movement as shown in FIGS. 1-3.

As indicated in FIG. 1, actuating lever 15 is configured to perform an idle stroke at a pivoting angle α of operating section 20 of at least 15° between the ready position B1 and an operating position A. For this purpose, an actuating section 40 of actuating lever 15 in the ready position B1 of operating section 20 is spaced apart from clamping leg 8 in the closed position S. When actuating lever 15 is actuated, actuating section 40 is therefore first moved towards clamping leg 8 until a pivoting angle α of operating section 20 corresponding to the working position A is reached before force is transmitted to clamping leg 8. An initial idle stroke can make it easier to operate actuating lever 15. FIG. 3 also shows that operating section 20 can be pivoted through a pivoting angle α of at least 60° between the ready position B1 and the actuation position B2 in order to improve user experience and to ensure that clamping leg 8 is securely moved to the open position O.

As can be gathered further from FIGS. 1-3, conductor terminal 1 has a separately formed functional element 28, which has a retaining contour 13 and a release mechanism 14 for each connection and is also shown in a separate illustration in FIG. 6. As can be seen in FIG. 6, functional element 28 has a retaining section 29 with a retaining contour 13 in the form of a latching contour for holding clamping leg 8 in the open position O. Functional element 28 also has a release section 30, which can be mechanically contacted by inserted conductor 12, in the form of a release pedal for releasing clamping leg 8. By deflecting the release pedal, interaction between retaining contour 13 and clamping leg 8 can be canceled and clamping leg 8 released as a result. Functional element 28 can be optimized by a separate design independently of the other components with regard to its retaining and release function.

FIG. 4 shows an assembly of conductor terminal 1 with busbar 5, clamping spring 6, and functional element 28. Clamping leg 8 of clamping spring 6 is shown in its closed position S. When manufacturing conductor terminal 1, the components mentioned can be pre‑assembled to form the assembly shown in FIG. 4 and inserted into insulating material housing 2. FIG. 4 also shows that functional element 28 is suspended from contact leg 7 of clamping spring 6, so that a self-supporting arrangement is created. For this purpose, a cutout 49, shown in FIG. 6 and penetrated by a curved material tongue 50 of contact leg 7, is formed in retaining section 29 of functional element 28. It can be seen furthermore that busbar 5 has a support frame 36 for supporting functional element 28.

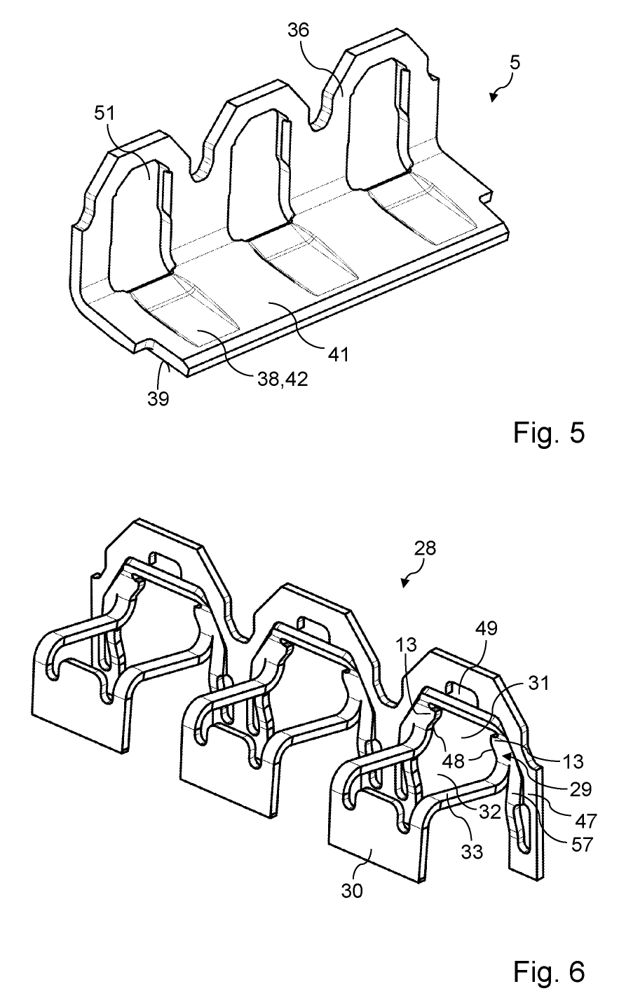

FIG. 5 shows a separate illustration of busbar 5, in which it can be seen that busbar 5 has a strip-shaped connecting bar 41 with conductor-receiving corrugations 42, which adjoin or form a clamping projection 52, to form a clamping point on a clamping surface 38 and a support frame 36, bent away from connecting bar 41, to support functional element 28. Support frame 36 also has one through opening 51 per connection, through which clamping leg 8, contact leg 7, and electrical conductor 12 can be passed.

FIG. 6 shows a separate illustration of functional element 28. In addition to retaining section 29 and release section 30, it can be seen that functional element 28 has a pass‑through opening 31 in retaining section 29 for guiding electrical conductor 12 to release section 30, whereby a compact design of conductor terminal 1 can be realized. Retaining section 29 forms a frame-like structure with side webs 57, which laterally delimit pass-through opening 31. In the open position O, clamping leg 8 can enter pass-through opening 31 partially and be supported on retaining section 29. It is further evident in FIG. 6 that retaining contour 13 is designed as a latching projection which projects into pass-through opening 31 and on which clamping leg 8 can be latched. Retaining contour 13 can be moved and/or elastically deformed by a tensile load on release section 30 in order to cancel an interaction with clamping leg 8 latched to retaining contour 13. A guiding slope 48 adjoins the latching projection in order to facilitate guiding clamping leg 8 into engagement with retaining contour 13 and to latch it securely there. Functional element 28 also has a support contour 55 with two support struts 47 which run parallel to one another and are connected to one another by a crossbar. Functional element 28 can be supported on support frame 36 of busbar 5 with support contour 55. Support contour 28 frames retaining section 29 with retaining contour 13 in an arc. Retaining section 29 and support contour 55 are formed in one piece with functional element 28. Retaining section 29 is cut out of support contour 55. Side webs 57 of retaining section 29 are compressed above a root region of retaining section 29 at support contour 55, so that side webs 57 are movable independently of support contour 55. Support frame 36 of busbar 5 has a through opening 51 that matches pass-through opening 31. FIG. 6 also illustrates that retaining section 29 and release section 30 are connected to one another by two webs 33 spaced apart by a free space 32, which can promote a slight deflection of release section 30 and a reliable displacement or elastic deformation of retaining contour 13. Webs 33 merge into a frame-like structure of retaining section 29 and are cut out from it. Viewed from the side, functional element 28 is U-shaped, wherein retaining section 29 and release section 30 form the U-legs and webs 33 form the U-base.

It can also be seen in FIG. 6 that retaining section 29 has an angled abutment tab 56. In conjunction with FIGS. 1-3, it can be seen that clamping leg 8 held in the open position O is not only supported on retaining contour 13, but also rests with clamping edge 43 on abutment tab 56. This ensures a defined overlap of retaining contours 13 relative to clamping edge 43 of clamping leg 8 that is independent of manufacturing and assembly tolerances, so that defined, uniform release forces can always be ensured. Abutment tab 56 can form a stop for clamping leg 8, which is moved into the open position O by means of actuating lever 15. Abutment tab 56 connects side webs 57 of retaining section 29. In addition, as can be seen in FIG. 4, for example, material tongue 50 of contact leg 7 can be supported on abutment tab 56 on the side of abutment tab 56 facing away from clamping leg 8.

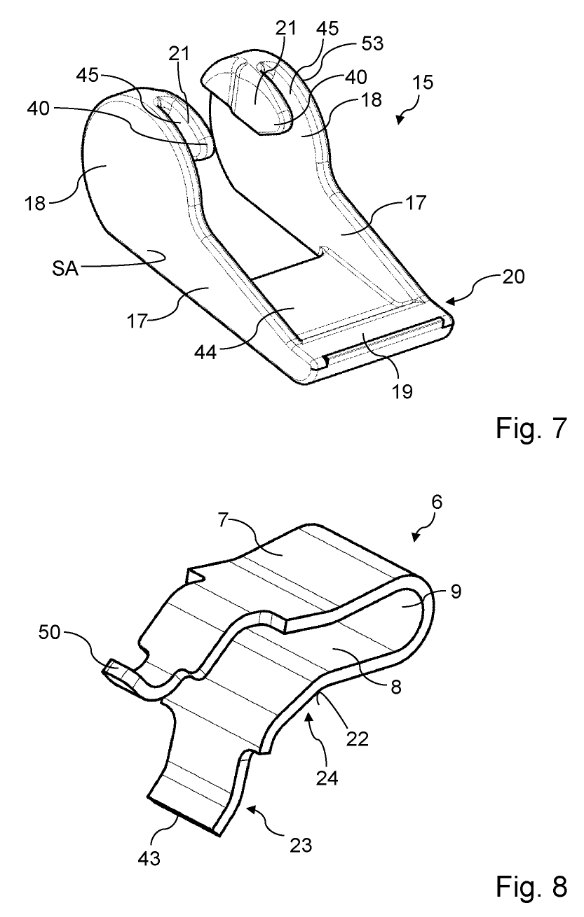

FIG. 7 shows a separate illustration of actuating lever 15. It can be seen in FIG. 7 that actuating lever 15 has a symmetrical U-shape with bearing legs 17 which run parallel to one another and are connected to one another by a crossbar 19 forming operating section 20. As a result, actuating lever 15 is formed to be stable and provided with a symmetrical bearing. Bearing disks 18 are formed on bearing legs 17 and have an arc-shaped bearing contour 53 for supporting and sliding on a counter-bearing contour 54 of insulating material housing 2. As can be seen in FIG. 7, the surface of bearing disk 18 takes up at least 60% of an entire side surface SA of bearing leg 17 and thus forms a pronounced guiding surface for electrical conductor 12 that is largely free of interfering edges. Between bearing legs 17, in each case an actuating wing 21 connected to a bearing leg 17 is arranged, with an actuating section 40 for mechanical contact with clamping leg 8. Actuating wings 21 extend parallel to bearing disks 18 and are each spaced from them by a slot 45. In particular, a housing wall of insulating material housing 2 can be inserted into slot 45 and enable or improve guidance of actuating lever 15. Operating section 20 has a cover 44, which has a continuous surface and improves the clearance and creepage distances of terminal 1 when operating section 20 is in contact with insulating material housing 2 in the ready position B1. Crossbar 19 forms an operating edge of operating section 20, which can be gripped by a user, in order to conveniently pivot actuating lever 15 into the actuating position B2.

FIG. 8 shows clamping spring 6. In conjunction with FIG. 3, it can be seen that clamping leg 8 has an actuating surface 22, which is formed in a central section 24 adjoining an end section 23, so that a short actuating path can be realized. In principle, actuating surface 22 can also be formed in end section 23 in order to achieve a favorable leverage ratio. Clamping leg 8 also has a clamping edge 43 for mechanical contacting and exerting force on electrical conductor 12. End section 23 adjoins clamping edge 43 and can extend along clamping leg 8 over a length of maximum 10% of the total length of clamping leg 8. Actuating surface 22 can be formed at a bend of clamping leg 8 in central section 24. Clamping spring 6 can be hooked into busbar 5 and functional element 28 with material tongue 50 at the end of contact leg 7.

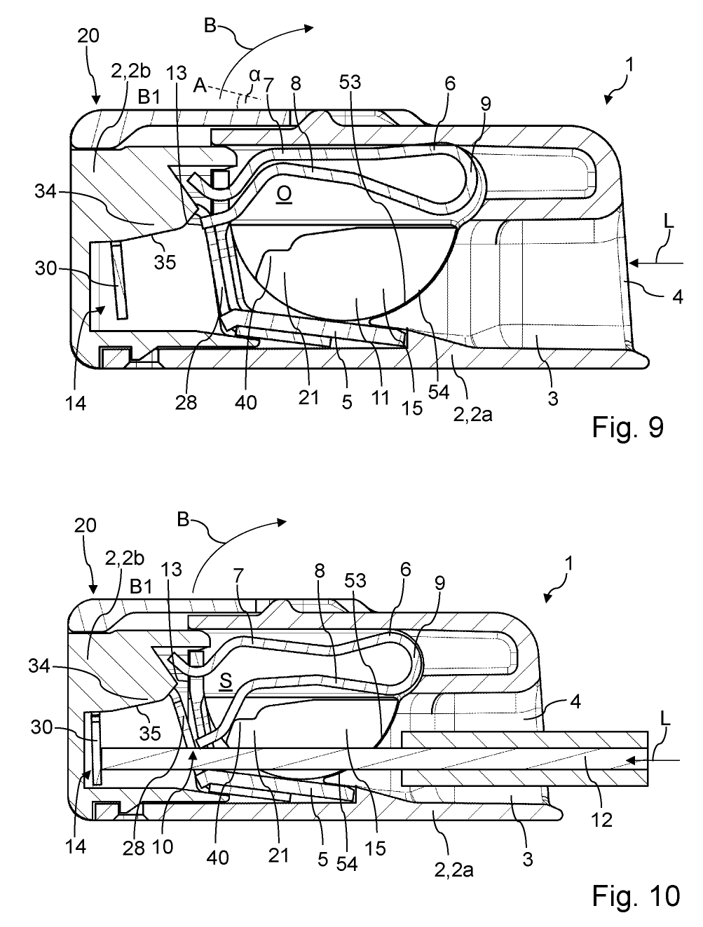

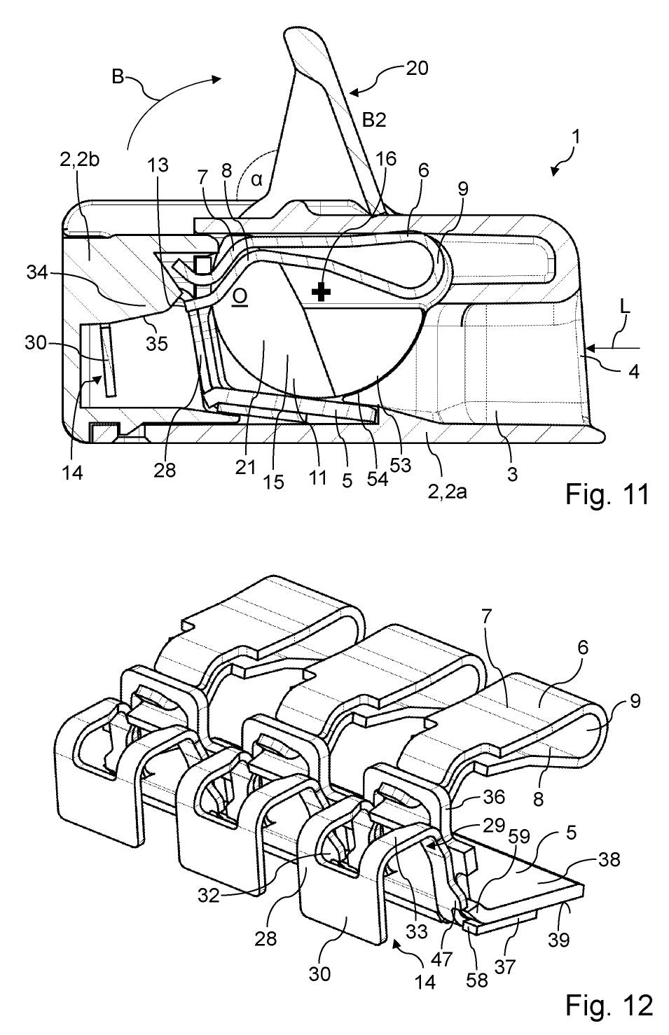

FIGS. 9-16 show a conductor terminal 1 and selected assemblies and components of conductor terminal 1 according to a second example. FIGS. 9-11 illustrate different states of conductor terminal 1. Conductor terminal 1 according to the second example is comparable to conductor terminal 1 according to the first example in terms of its basic structure and mode of operation, so that the differences between the second example and the first example are mainly discussed below.

Thus, for example, it can be seen in FIGS. 9-11 that insulating material housing 2 is formed of multiple parts and formed of a base housing 2a and a cover part 2b designed as a side cover. Cover part 2b faces release mechanism 14 of conductor terminal 1. In addition, functional element 28 has a design that differs from the first example, which will be explained in more detail below in connection with the other figures.

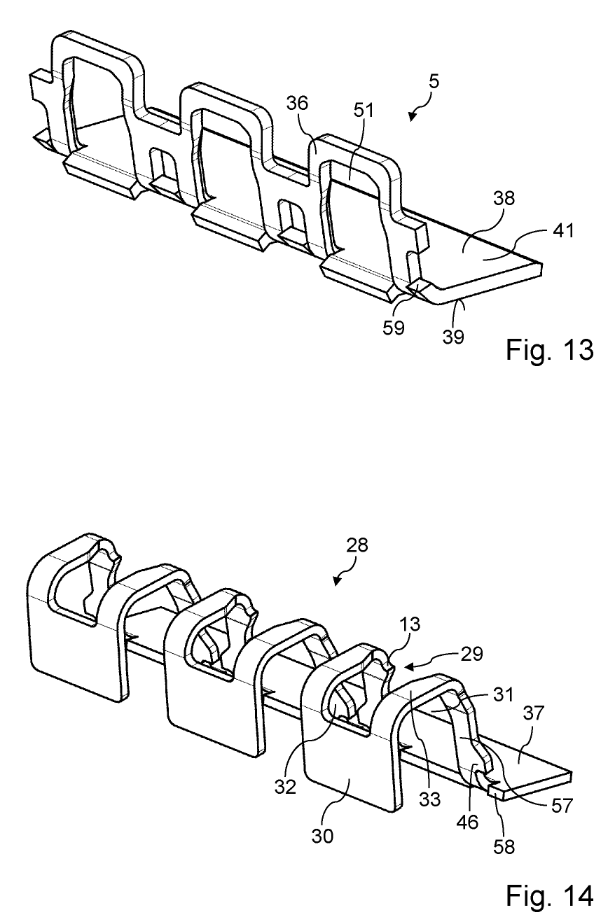

FIG. 12 shows an assembly of conductor terminal 1 with busbar 5, clamping spring 6, and functional element 28. When manufacturing conductor terminal 1, the components mentioned can be pre-assembled to form the assembly shown in FIG. 12 and inserted into insulating material housing 2. Furthermore, it can be seen in FIG. 12 that functional element 28 has a bearing bar 37 for contact with an underside 39 of busbar 5, wherein underside 39 faces away from a clamping surface 38 of busbar 5. Bearing bar 37 can be used to clamp functional element 28 under connecting bar 41 of busbar 5 and thus hold it securely in conductor terminal 1. FIG. 13 also shows a separate illustration of busbar 5.

FIG. 14 shows a separate illustration of functional element 28. It is evident in FIG. 14 that according to the second example of conductor terminal 1, retaining section 29 and release section 30 are also connected to one another by two webs 33 spaced apart from one another by a free space 32. It can be gathered from FIGS. 9-11 that a housing section 34 of insulating material housing 2 enters free space 32 between webs 33 and forms a conductor-guiding surface 35 for the inserted electrical conductor 12. An easier guiding of conductor 12 to release section 30 is enabled thereby, wherein premature triggering of release mechanism 14 can be avoided by contact between conductor 12 and webs 33. Housing section 34 can be formed integrally with cover part 2b as shown in FIGS. 9-11. It can be seen further in FIG. 14 that a support tab 46 in retaining section 29 of functional element 28 projects laterally, with which functional element 28 can be supported, for example, on a projection of insulating material housing 2. In addition, a latching tab 59 of busbar 5 can be snap-received between support tab 46 and a clamping tab 58 projecting from bearing bar 37, as shown in FIG. 12, in order to support a reliable bearing of bearing bar 37 against underside 39 of busbar 5 and to achieve an interengagement of functional element 28 with busbar 5. Functional element 28 can have a lower material thickness than clamping spring 6. For example, functional element 28 can be made from a thinner sheet metal part than clamping spring 6.

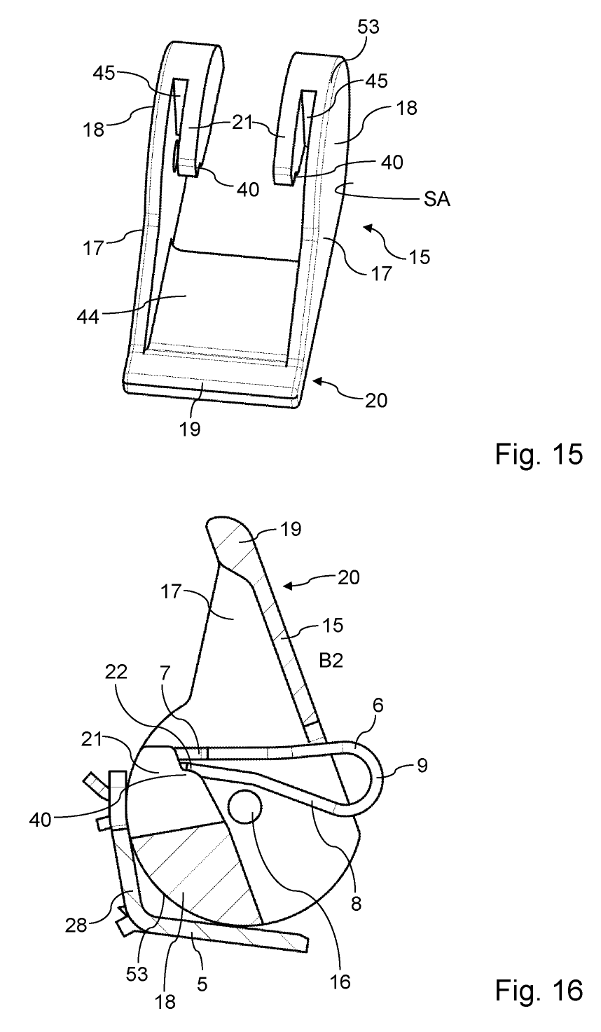

FIG. 15 shows a separate illustration of actuating lever 15. The U-shaped design, operating section 20, bearing legs 17, and actuating wings 21 with actuating sections 40 are comparable to actuating lever 15 according to the first example. In FIG. 16, busbar 5, clamping spring 6, and operating section 20, pivoted into the actuating position B2, are also shown in a sectional side view in order to illustrate the entrainment of clamping leg 8 by actuating wing 21 through the interaction of actuating surface 22 with actuating section 40 when actuating lever 15 is pivoted.

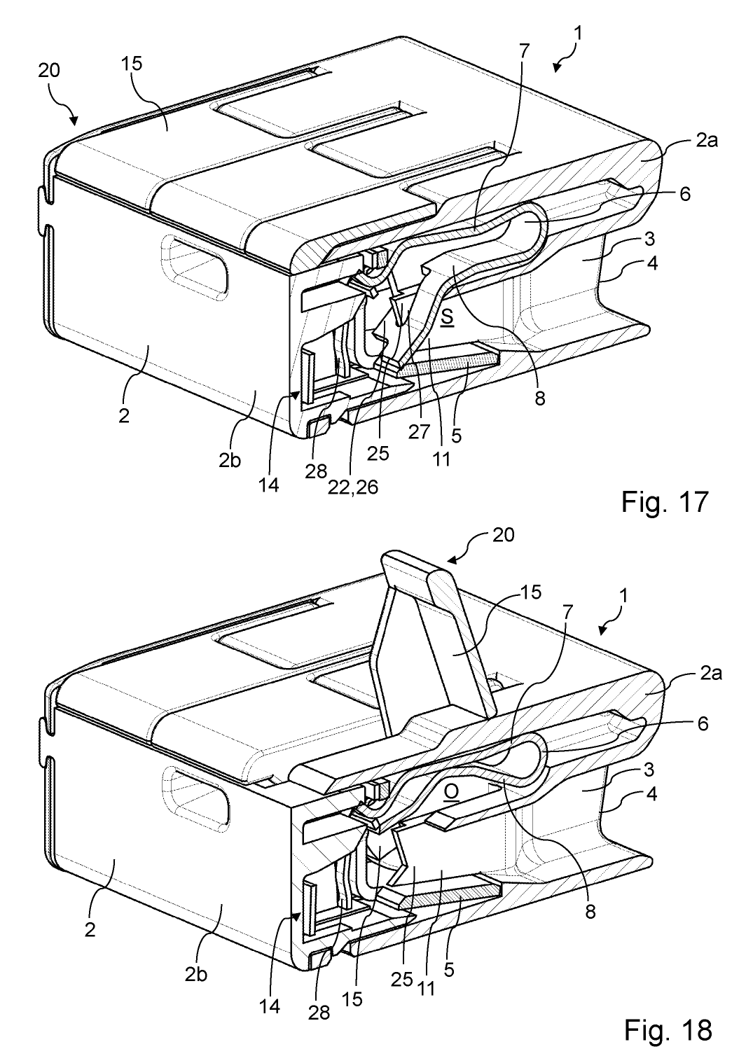

FIGS. 17 and 18 show a perspective view of a conductor terminal 1 according to a third example. Clamping leg 8 is shown in the open position O in FIG. 18 and in the closed position S in FIG. 17. It can be gathered from FIG. 17 that an actuating surface 22 of clamping leg 8 is formed on a laterally projecting actuating tab 26 of clamping leg 8, which is spaced from clamping leg 8 by a gap 27. A housing wall 25 enters gap 27. Housing wall 25 extends partially between actuating lever 15, which is concealed by housing wall 25 in FIG. 17, and conductor-receiving space 11. This achieves a favorable spatial separation of the actuating area and the conductor area and enables interference-free insertion of conductor 12 along housing wall 25. Actuating tab 26 of clamping leg 8 is guided around housing wall 25.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor terminal comprising:
an insulating material housing;
a busbar;
a clamping spring having a contact leg and a clamping leg, the clamping leg together with the busbar forms a clamping point for an electrical conductor that is adapted to be inserted, in a conductor insertion direction, through a conductor insertion channel into a conductor‑receiving space of the conductor terminal, the clamping leg adapted to be moved between an open position and a closed position to open and close the clamping point;
a retaining contour to hold the clamping leg in the open position;
a release mechanism adapted to be actuated by the inserted electrical conductor to release and automatically move the clamping leg into the closed position; and
a pivotable actuating lever with an operating section, which is adapted to be pivoted in an actuation direction from a ready position into an actuating position to move the clamping leg from the closed position into the open position, the actuation direction of the operating section being opposite to the conductor insertion direction of the electrical conductor.

2. The conductor terminal according to claim 1, wherein the actuating lever is pivotable about an axis of rotation that runs offset from the conductor insertion channel and the conductor-receiving space.

3. The conductor terminal according to claim 1, wherein the actuating lever is mounted on the busbar and/or on the insulating material housing.

4. The conductor terminal according to claim 1, wherein the actuating lever is configured to perform an idle stroke at a pivoting angle of the operating section of at least 15° between the ready position and an operating position.

5. The conductor terminal according to claim 1, wherein the operating section is adapted to be pivoted through a pivoting angle of at least 60° between the ready position and the actuating position.

6. The conductor terminal according to claim 1, wherein the actuating lever has a U-shape with bearing legs that run substantially parallel to one another and are connected to one another by a crossbar, and wherein an actuating wing is located between the bearing legs for mechanical contacting of the clamping leg.

7. The conductor terminal according to claim 1, wherein an actuating surface of the clamping leg is formed in an end section of the clamping leg.

8. The conductor terminal according to claim 1, wherein an actuating surface of the clamping leg is formed in a central section of the clamping leg.

9. The conductor terminal according to claim 1, wherein a housing wall of the insulating material housing is arranged at least partially between the actuating lever and the conductor-receiving space and/or the conductor insertion channel.

10. The conductor terminal according to claim 9, wherein an actuating surface of the clamping leg is formed on a laterally projecting actuating tab of the clamping leg, wherein the actuating tab is spaced from the clamping leg by a gap, and wherein the housing wall enters the gap.

11. The conductor terminal according to claim 1, wherein the conductor terminal has a functional element on which a retaining section, with the retaining contour for holding the clamping leg in the open position. and a release section, which is adapted to be mechanically contacted by the inserted conductor to release the clamping leg, are formed.

12. The conductor terminal according to claim 11, wherein the functional element has a pass-through opening for guiding the electrical conductor to the release section.

13. The conductor terminal according to claim 12, wherein the retaining contour is formed as a latching projection projecting into the pass-through opening.

14. The conductor terminal according to claim 11, wherein the retaining section and the release section are connected to one another by two webs spaced apart from one another by a free space.

15. The conductor terminal according to claim 14, wherein a housing section of the insulating material housing enters the free space between the webs and forms a conductor-guiding surface for the inserted electrical conductor.

16. The conductor terminal according to claim 11, wherein the functional element is suspended from the contact leg of the clamping spring.

17. The conductor terminal according to claim 11, wherein the functional element has a lower material thickness than the clamping spring.

18. The conductor terminal according to claim 11, wherein the busbar has a support frame and/or the functional element has a support contour for supporting the functional element on the busbar.

19. The conductor terminal according to claim 11, wherein the functional element has a bearing bar for bearing against an underside of the busbar, the side facing away from a clamping surface of the busbar.

20. The conductor terminal according to claim 11, wherein the retaining section has a abutment tab for contacting the clamping leg held in the open position.
